(19) United States
(12) Patent Application Publication
(10) Pub. No.: US 2018/0155221 A1
(43) Pub. Date: Jun. 7, 2018

(54) WATER TREATMENT SYSTEM AND METHODS USING RADIAL DEIONIZATION

(71) Applicant: Atlantis Technologies, Dana Point, CA (US)

(72) Inventors: Patrick Michael Curran, Laguna Niguel, CA (US); Ryan Gilmore, Dana Point, CA (US); Jacob Silverman, Lake Forest, CA (US)

(73) Assignee: Atlantis Technologies, Dana Point, CA (US)

(21) Appl. No.: 15/821,522

(22) Filed: Nov. 22, 2017

Related U.S. Application Data
(60) Provisional application No. 62/425,859, filed on Nov. 23, 2016.

(51) Int. Cl. C02F 1/469; C02F 1/461; C02F 5/00

(52) U.S. Cl. CPC C02F 1/4691; C02F 2103/023; C02F 5/00; C02F 1/46104

(57) ABSTRACT

Apparatuses, systems, and methods for treating cooling tower water with a radial deionization unit are disclosed. The radial deionization unit may alone or in conjunction with other treatment units treat a make-up water being fed to a cooling tower, in order to remove dissolved solids from the water. The radial deionization unit may, in some cases, receive reclaimed water from the cooling tower or other unit operations

### RELATED APPLICATIONS

This application claims priority to U.S. Provisional Application No. 62/425,859, filed Nov. 23, 2016, which is incorporated herein by reference in its entirety.

### TECHNICAL FIELD

Systems and methods for treating water produced by and/or fed to a unit operation, such as a cooling tower, with a radial deionization unit are generally described.

### BACKGROUND

Evaporative cooling towers are widely used in industrial power generation and HVAC systems. They utilize a heat exchanger and a large volume of recirculating water to remove vast quantities of heat from a thermodynamic process via a heat exchanger or other operation by using water cooled by evaporation to cool the recirculating water. Methods for increasing the water utilization efficiency and evaporative performance of cooling towers exist, but they often rely on dosing chemicals into the recirculating water to soften or otherwise treat the water. The use of desalination systems for treating cooling tower water is generally known. But many typical desalination systems, such as reverse osmosis require that silica and chlorine be removed from the cooling tower feed water prior to entry into the desalination system because these elements will foul or permanently ruin the system. This operation causes additional costs to be incurred for removal, and in the case of chlorine, causes the chemical to have to be re-added to the water after exiting the desalination system. Methods of water treatment exist to improve the water utilization efficiency of evaporative cooling towers. Conventional chemical dosing, water softening, and desalination are examples. The first two are used extensively in industry but they require a high cost of consumables (chemicals and salt), a high cost of maintenance, and they are limited in their potential water savings. Desalination systems have generally not been widely put to use for reasons including the need for silica and chlorine removal, as mentioned above and other limitations with typical conventional desalination technologies. Reverse Osmosis would normally be a popular choice, but it is typically unable to provide a water recovery rate (percentage of total water fed into a treatment unit that is produced as treated water) above 75%. Likewise, use of conventional capacitive deionization systems provides a water recovery rate typically limited to about 85% or less. Accordingly, improved systems and methods for treating cooling tower water and/or improving cooling tower water utilization efficiency to provide an increased water recovery rate are needed.

### SUMMARY

Apparatuses, systems, and methods related to water treatment with a radial deionization unit are generally described. The subject matter of the present invention involves, in some cases, interrelated products, alternative solutions to a particular problem, and/or a plurality of different uses of one or more systems and/or articles.

According to one or more embodiments, an evaporative cooling system is provided. The system may comprise a cooling tower unit; and a radial deionization unit fluidically coupled with the cooling tower unit.

According to one or more embodiments, a method for operating an evaporative cooling system is provided. The method may comprise treating water from a source of water in a radial deionization unit to produce a treated water; and delivering the treated water to a cooling tower unit of the evaporative cooling system.

According to one or more embodiments a water treatment method using a radial deionization unit to produce a treated water stream is provided, introducing a first water stream to a first radial deionization unit during a first cycle of operation of the first radial deionization unit to produce the treated water stream; introducing the treated water stream to a first unit operation; and introducing a second water stream to the first radial deionization unit during a second cycle of operation of the radial deionization unit to produce a reject water stream; wherein the second water stream comprises reclaimed water from the first unit operation or from a second unit operation.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is schematic drawing of a cooling tower system, according to one or more embodiments;

FIG. 2 is a schematic drawing of a cooling tower system, according to one or more embodiments;

FIG. 3 is a schematic drawing of a cooling tower system, according to one or more embodiments;

FIG. 4 is a schematic drawing of a cooling tower system, according to one or more embodiments;

FIG. 5 is a schematic drawing of an RDI unit and associated flowlines, according to one or more embodiments;

FIG. 6 is a schematic drawing of a cooling tower system, according to one or more embodiments; and

FIG. 7 is a schematic drawing of a cooling tower system, according to one or more embodiments;

FIG. 8 is a schematic drawing of a control system for use with a cooling tower system, according to one or more embodiments;

FIG. 9 is a graph comparing flow rate to flux rate of removed ions for a given inlet stream total dissolved solids TDS, illustrating performance of one exemplary embodiment;

FIG. 10 is an isometric view of a portion of a cylinder of a radial deionization unit, according to one or more embodiments;

FIG. 11 is a cross-section view of a concentric layer of a cylinder of a radial deionization unit, according to one or more embodiments;

FIG. 12 is a cross-section of multiple concentric layers of a cylinder of a radial deionization unit, according to one or more embodiments;

FIG. 13 is an angle view of a spiral wound cylinder of a radial deionization unit, according to one or more embodiments; and

FIG. 14 is an end view of a spiral wound cylinder of a radial deionization unit, according to one or more embodiments.

### DETAILED DESCRIPTION

Systems and methods for treating water produced by and/or fed to a unit operation, such as a cooling tower, with a radial deionization unit are generally described.

Unit operations processing or utilizing water or aqueous streams are ubiquitous in industry. Many such unit operations require or can benefit from pre- and/or post-treatment of the water or aqueous stream the use or process to remove undesirable components, such as ionic species and salts. Embodiments of the invention provide water treatment systems and methods for these and other purposes. For example, evaporative cooling towers are widely used in industrial power generation and heating, ventilation, and air conditioning (HVAC) systems. They typically utilize a heat exchanger and can in certain cases process a large volume of recirculating water to remove vast quantities of heat from a thermodynamic process by using water cooled by evaporation to cool the recirculating water. The majority of the heat is removed from the system via evaporation into the atmosphere. There are at least two significant problems with conventional setups. The first problem is that the basin of the cooling tower must be constantly replenished with additional water in order to maintain a minimum volume due to evaporative losses. The second problem is that while pure water evaporates, any minerals in the water are left behind and become concentrated in the basin. The salinity of the recirculating water thus increases over time, and eventually can cause damage to certain components in the cooling tower. These problems can be mitigated by constantly supplying the cooling tower basin with fresh water, henceforth called make-up water, and periodically draining the accumulated, salty water from the basin, henceforth called blowdown water. This process is not particularly efficient from an operational efficiency or water savings perspective because it is time consuming and also results in an enormous volume of brine sent down the drain. On the average, 0.3 to 0.5 gals of brine are generated for every gal of clean water supplied to a typical cooling tower.

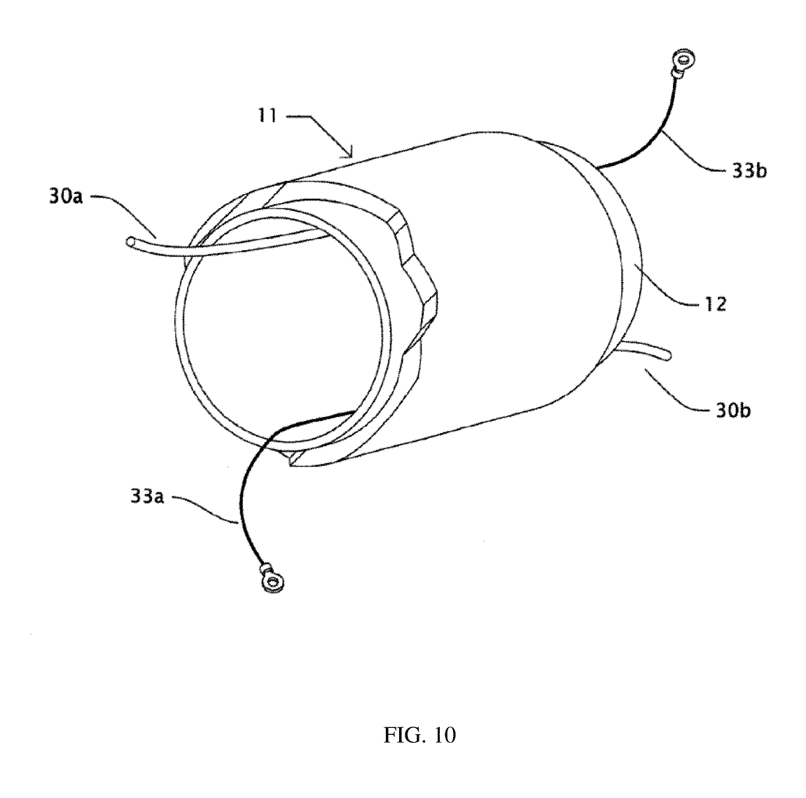

According certain embodiments, methods and systems described herein are able to increase the operational and/or water utilization efficiency of water processing or handling unit operations, such as evaporative cooling towers, and, in certain cases, also lower operating costs. This can be done, in certain embodiments, by pairing such a water processing or handling unit operation, such as an evaporative cooling tower system, with a radial deionization (RDI) unit, also referred to as a radial capacitive deionization unit. The unit may comprise a set of RDI cylinders that treat the water. The cylinders may be arranged in series and/or parallel. Aspects of individual cylinders are discussed below, for example with relation to FIGS. 10-14. This coupling leads to the possibility of a wide variety of configurations and improved processes within the scope of the invention that can, in certain cases, be used to achieve any one or more of that ability to reduce overall water consumption, reduce operating costs, reduce materials costs, reduce waste, improve operating efficiency, improve performance, improve lifespan, and/or other benefits.

Radial deionization is a process for ion removal from a fluid source. A radial deionization unit comprises a plurality of concentrically or spirally arranged opposed capacitor pairs with a dielectric spacer that forms a flow path interposed between the capacitors. Radial deionization may be understood to be a form of capacitive deionization, albeit in certain embodiments with advantages over traditional capacitive deionization.

Capacitive deionization devices have been developed over the last 20 years as a possible replacement for or alternative to the more traditional deionization methods, including reverse osmosis, electrodeionization, continuous electrodeionization, ion exchange resins, lime softening, etc. Capacitive deionization typically has the ability to remove ions with lower energy and reduced fouling compared to typical traditional deionization techniques. Unfortunately, typical conventional capacitive deionization devices can suffer from limitations discussed below.

Capacitive deionization works as follows. An aqueous stream containing undesirable ions is fed into a capacitive deionization cylinder containing one or more pairs of electric double layer capacitors. A power supply is electrically coupled with opposing electrodes of the pairs, and the capacitors are charged. A dielectric material or layer is positioned in between the opposing electrodes, they hold their charge just like a standard capacitor.

When the capacitors are charged during a water treatment (cleaning) cycle of operation, the cations and anions are attracted by and move toward an electrode having an opposite charge than the ionic species (i.e. cations migrate towards the negatively charged electrode(s) and anions migrate towards the positively charged electrode(s)) are thereby removed from water, e.g. by being adsorbed onto a capacitor electrode, which is typically made of carbon. The cylinder will eventually become saturated with ions and need to be regenerated. When this occurs, the polarity of the double layer capacitor is reversed, and the ions are rejected from the surface of the respective electrodes to which they are adsorbed and into a reject water stream for disposal or collection, etc. Unfortunately, timing and space constraints of traditional capacitive deionization devices do not typically sufficiently prevent contamination of a cleaned water stream and by a previously rejected stream concentrated in the undesirable ionic species for many purposes. Because these two streams can partially mix together, the purification ability of a traditional capacitive deionization device is limited. This undesirable intermixing typically is the result of relatively large dead volume spaces within the devices, and other performance limiting issues that are difficult to avoid given conventional design constraints.

By contrast, a radial deionization unit is distinguished from the above-described capacitive deionization devices of more conventional design by their radial design in which the electrode pairs forming the capacitors are disposed as separate concentric or spiral shaped layers form a cylinder about a central axis, rather than having the more standard plate configuration of the above described conventional designs. Radial deionization devices of certain embodiments may include charge barriers, such as semi-permeable membranes, that prevent discharged ions from re-adsorbing onto the opposing capacitor electrodes when the cylinder is switched to a reject cycle and the capacitors' polarities are reversed. Certain embodiments also may employ radial deionization cylinders including one or more electrical connections at least partially disposed within an inner support tube. One or more associated cylinders form a unit. Aspects of radial deionization units useful or adaptable for use in certain embodiments described herein are discussed in greater detail in U.S. Pat. No. 9,193,612, entitled “Concentric Layer Electric Double Layer Capacitor Cylinder, System, and Method of Use,” and U.S. Pat. No. 9,633,798, entitled “Atomic Capacitor,” each of which is incorporated by reference herein in their entireties and for all purposes.

Although RDI is a form of capacitive deionization, it can in certain cases have certain advantages over typical conventional capacitive deionization systems in terms of one or more of capital cost, operating cost, and water recovery. In particular, the inventors have developed and describe herein unexpected and/or synergistic effects by incorporating an RDI unit(s) into an a water treatment, processing, or utilizing system—e.g. an evaporative cooling system, such as a cooling tower system—to provide, in certain cases, and improved performance (e.g. improved water recovery rate, operating cost, etc.) over other typical water treatment technologies, including those that are known to have been fluidically coupled with a cooling tower unit such as including reverse osmosis, electrodeionization, continuous electrodeionization, ion exchange resins, lime softening, etc.

The design and configuration of the RDI cylindrically disposed electrodes can in certain cases enable higher recovery of clean water, which results in water and cost savings. For example, where a traditional capacitive deionization system may have a maximum of 75% water recovery rate (percentage of total water fed into a treatment unit that is produced as treated water), embodiments incorporating RDI as disclosed herein are capable in certain embodiments of achieving greater than a 90% recovery, which can result in a significant amount of water savings, particularly for systems employing cooling towers.

With respect to systems employing cooling towers, other methods for increasing the water efficiency have been attempted, but they often rely on dosing chemicals into recirculating water within the system. Treatment of cooling tower water using an RDI according to certain embodiments, may have substantial operational, environmental, and economic advantages over such typical conventional methods for increasing the water efficiency of cooling towers and reducing the use of chemicals which end up going into sewer system and then into water ways and ocean. As mentioned above, many typically employed desalination systems do not well tolerate certain dissolved solids found in typical cooling tower feed streams. For example, many conventional desalination systems would require that silica, hardness, alkalinity, and chlorine be substantially removed from the cooling tower feed water prior to entry into the system because these elements could foul or otherwise damage the system. This requirement causes additional costs to be incurred for removal, and in the case of chlorine, may the chemical to have to be re-added to the water after exiting the desalination system, when chlorination of the cooling tower feed is desired for disinfection purposes.

Conventionally, three methods of water treatment have been used in an attempt to improve the water efficiency of evaporative cooling towers—chemical dosing, water softening, and desalination. The first two have been used more extensively in industry, but they entail a high cost of consumables (chemicals and salt), a high cost of maintenance, and they are limited in their potential water savings. Conventional desalination systems such as reverse osmosis or traditional capacitive deionization are unable to provide a water recovery rate above 75%. Capacitive deionization using an RDI system, as in the presently disclosed systems and processes, can, in certain embodiments, lead to recovery rates above 90%. This can result in many advantages and benefits, such as higher net water efficiencies.

In some embodiments, an evaporative cooling tower system comprises a cooling tower unit and a radial deionization unit fluidically coupled with the cooling tower unit. In some embodiments, an associated method comprises treating a source of water in a radial deionization unit to produce a treated water and delivering the treated water to a cooling tower unit. Additional aspects of these systems and methods are discussed herein.

According to some embodiments, an RDI unit is used for treating (e.g., deionizing and/or desalinating) the make-up water for an evaporative cooling tower. Treating the source of make-up water may comprises feeding the water into the radial deionization unit and at least partially removing at least one ionic species from the water to produce the treated water. The at least one ionic species at least partially removed may comprise one or more of Li, Na, Ca, Mg, K, U, Hg, Se, Ba, Sr, Fe, Mn, Cr, Ni, Cu, Zn, Sn, Sb, Pb, chlorides, sulfates, sulfides, sulfites, nitrates, phosphates, carbonates, borates, silica, selenates, selanites, bromides, iodides, and alkalines. At least one ionic species at least partially removed may comprise at least one hardness ion. At least one ionic species at least partially removed may comprise sodium and chlorine. The water from the source of water may be at least partially desalinated by the radial deionization unit.

Water may be fed to the RDI from a tank or pressurized line. When using a pressurized line, the RDI system may avoid the need for a pump, and water flow into the system may be controlled, for example, with a flow meter and/or control valve. Such embodiments may provide advantages over technologies such as reverse osmosis that cannot feed the water through the system solely with city water pressure but must utilize a high pressure, expensive, pump. Makeup water as fed to the RDI may be at room temperature, and often will have a conductivity between 300-2,000 μS/cm, although the RDI unit is capable of receiving feeds having a much higher conductivity, for example up to 200,000 μS/cm. After passage through the RDI, it may still be around room temperature, and the unit may be controlled to reduce conductivity over a full range of 0% to 99% as determined by the needs of an operator, or in some embodiments, by at least 25%, and in certain cases between 25% to 90%. In some embodiments the treated water has a conductivity of at least 10 μS/cm, 30 μS/cm, 100 μS/cm, or 300 μS/cm or within a range of any of these values. In some embodiments the treated water has a much higher conductivity (as high as 200,000 μS/cm). The conductivity of the treated can be controlled depending on the needs of the system. Multiple RDI cylinders of the RDI unit can be placed in series and/or in parallel to increase capacity and/or in order to further reduce the conductivity. In certain cases, 99% or more of the total pre-RDI makeup water fed to the RDI may be treated and pass onto the next stage as RDI-cleaned make-up water, with as little as 1% or less of the makeup water initially fed to the RDI being retained to be used during a reject cycle to produce a brine, which may be sent to the drain during a reject/regeneration cycle of operation of the RDI. The flow rate for during the water treatment step depends on a number of conditions particular to a specific application, including, but not limited to, the size of the cooling tower, the heat exchange requirements of the system, the ambient temperature, and the conductivity of the inlet water, etc. While typically not critical, the water pressure through the RDI unit may for certain typical applications be maintained at about 10 to 50 psi.

In certain cases, the cleaned water output from the RDI may be circulated directly into the cooling tower basin. Thus, a large percentage, of the dissolved solids can be removed from the stream before the water even enters the cooling tower. This can allow the cooling tower system to blowdown less frequently and to realize a higher net water efficiency.

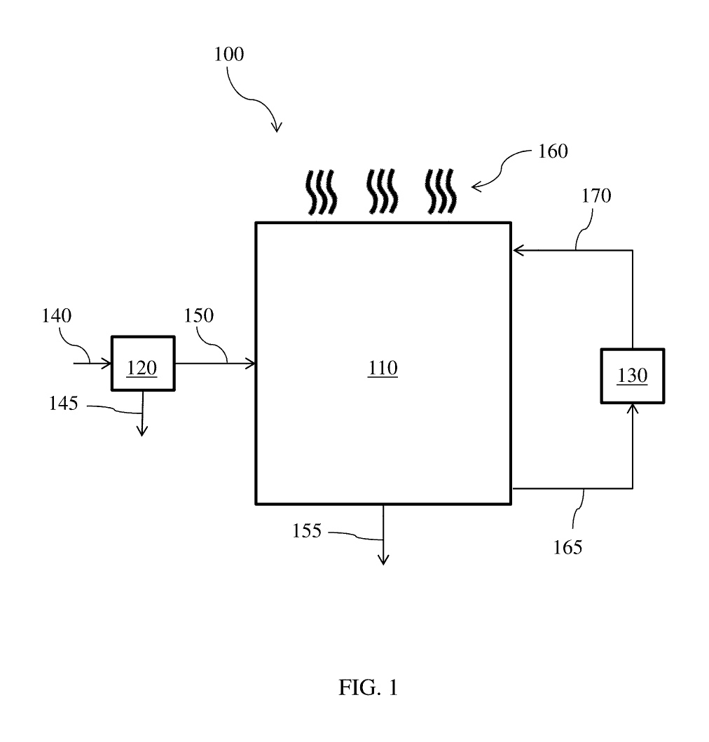

Several exemplary applications are illustrated in the figures and described below. As an example of such an embodiment, FIG. 1 discloses a cooling tower system 100, according to an embodiment of the invention. During operation, an evaporative cooling tower 110 cools warm water received from flowline 170, and recirculates the cooled water via flowline 165, where it may, once again absorb heat at a heat exchanger 130. During each cycle, a portion of the water evaporates (in some applications, up to 90%) and exits the cooling tower 110 as water vapor 160. This evaporation increases the concentrations of any dissolved solids in the circulation water, and requires that the fluid sometimes be flushed from the tank via drain line 155, in an operation referred to as blowdown.

Because of water lost to evaporation during operation of the cooling tower 110, a make-up water is generally supplied to the tower 110. In the embodiment shown in FIG. 1, a source of make-up water is first supplied to a radial deionization unit (“RDI unit”) 120 via flowline 140. When operating in a treatment mode (or equivalently using alternative language—a purification mode/cycle or cleaning mode/cycle), the RDI unit 120 removes a portion of the dissolved solids (ionic species) from the make-up water to produce a treated water having a reduced dissolved solids content. This treated make-up water is then delivered to the cooling tower 110 via flowline 150. Because the treated make-up water has a reduced solids content, the frequency of blowdowns can be reduced, resulting in a reduction in the amount of water needed to operate the system. The ions collected by the RDI unit during purification mode are eventually rejected during a desorption mode (or equivalently using alternative language—a discharge mode/cycle, reject mode/cycle or purge mode/cycle) and released to drain or for further processing via purgeline 145.

Some embodiments may optionally include a water softening unit, or other water treatment device, positioned in line with an RDI unit to offer additional treatment to the make-up water prior to its introduction to the cooling tower. The water softening unit may be a known ion exchange unit comprising ion-exchange resin or ion-exchange polymer, as would be understood by a person of ordinary skill in the art. Depending on the requirements of the system, the output water can optionally be passed through a water softener. In such a system and process, the water softener removes additional ions from the make-up stream, particularly divalent ions that cause hardness. Certain types of hardness can be extremely detrimental to the system and cause damage, clogging, and loss in heat exchange efficiency. Adding a water softener to the operation is optional, but may allow the total dissolved solids that can be tolerated within the cooling tower to rise further than otherwise because the ratio of hardness to total TDS may be lower than without such supplemental water softening. Because a water softener may facilitate a further reduction in the concentration of hardness-causing ions, hardness-causing ions can constitute a smaller ratio of the total TDS ratio than would otherwise be the case. Because the TDS makeup constitutes a lower ratio hardness-causing ions, the system may be able to tolerate a higher absolute TDS value. The conductivity set point of the blowdown sensor is typically set based on hardness or silica concentration in the tower basin water. For water that has less hardness per unit of water, the set point could be increased proportionally until the same hardness concentration is reached. This can further reduce the blowdown frequency, and therefore save additional water on top of that already saved by reducing the overall TDS with the RDI.

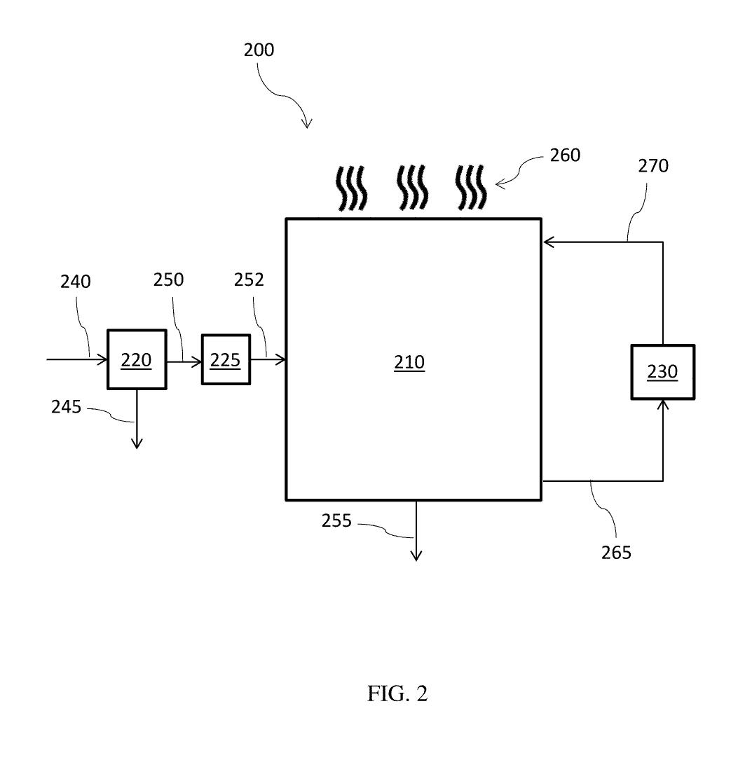

For example, the system 200, shown in FIG. 2, is similar to that of FIG. 1 with the additional incorporation of a water softening unit 225 fluidically positioned downstream of the RDI unit 220 and upstream of the cooling tower 210. Cooled water exiting the cooling tower via flowline 265 is heated at heat exchanger 230 then redelivered to the tower 210 via flowline 270, where the water is cooled with some exiting the tower 210 as vapor 260. A makeup-water is fed to an RDI unit 220, in which dissolved solids are removed, via flowline 240. The treated water is then delivered to a water softener 225 for a polishing step where additional dissolved solids, particularly hardness ions, are further removed. The final treated water is then delivered to the cooling tower via flowline 252. Because the make-up water has a reduced solids content, less frequent blowdowns via drain line 255 are required, resulting in a more efficient use of water. Occasionally, adsorbed ions are released from the RDI unit 220 via purge line 245.

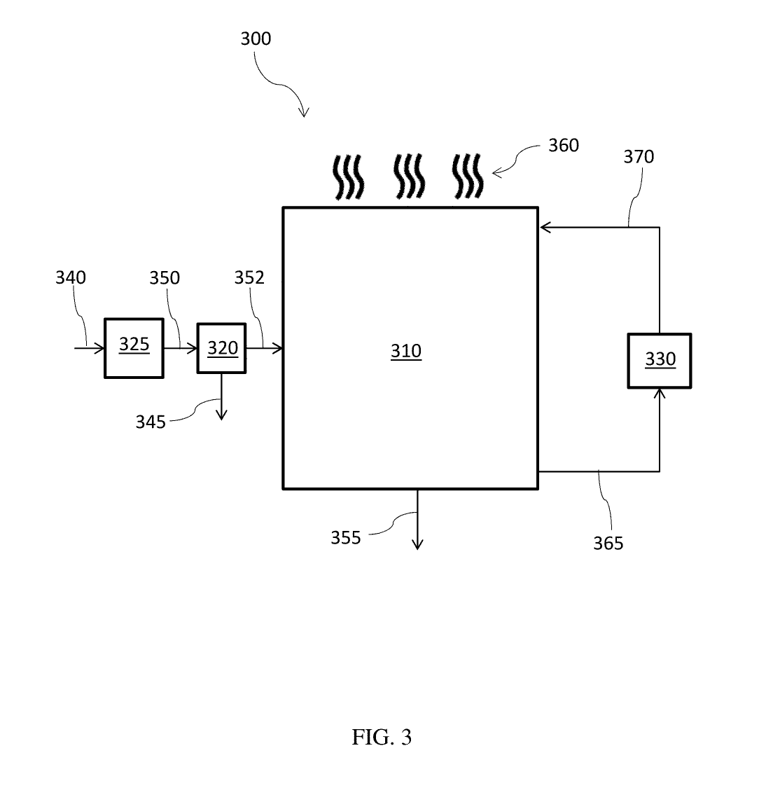

Alternatively, a water softening unit may be positioned upstream of an RDI unit. For example, in FIG. 3 the system 300 comprises a cooling tower 310 with a make-up water supply. The cooling tower 310 recirculates water to heat exchanger 330 via lines 365 and 370. Make-up water is delivered to a water softening unit 325 via flowline 340. The softened water is then delivered via flowline 350 to a radial deionization unit 320, for further removal of dissolved solids. The treated water is then delivered to the cooling tower 310 via line 352, while a brine enriched with the removed ions is delivered to waste or for further processing via purge line 345. The water treatment regime replenishes the water lost to evaporation 360, while reducing the amount of blowdown water via drain line 355.

Both of these modes of operation (system 200 and system 300) can be useful, depending on the application, but they have two main differences. The system 200 of FIG. 2 has a higher ionic loading through the RDI unit 220, and the system 300 of FIG. 3 has a higher ionic loading through the water softener 325. In general, a higher ionic loading leads to a higher rate of depreciation of performance and a higher cost of maintenance over time. Preference in the order of these two units may depend on the particular application, but generally it is preferable to place the RDI unit upstream of the water softener (as shown in FIG. 2) because RDI units often work more effectively with a higher TDS loading than water softeners can and may provide lower operating and maintenance costs.

An alternative approach to controlling the conductivity of the recirculating cooling tower water is to desalinate the water as it recirculates. According to some embodiments, the conductivity of the recirculating cooling tower water may be controlled by circulating water from the cooling tower unit through an RDI unit, which delivers the treated water back to the cooling tower unit. Instead of, or in addition to, desalinating the make-up water before it reaches the basin of the cooling tower as illustrated in FIGS. 1-3, the system may be configured to desalinate the water as it recirculates. This mode of operation may be referred to as side-streaming or feed-and-bleed. Use of RDI in such a system may provide advantages in water recovery. Water from the cooling tower basin can be fed into and through the RDI over a range of temperatures (e.g., from 5° C. to 90° C.), including at elevated temperatures (e.g. from 60° C. to 90° C.). The water pressure may typically be between 0-125 psi. The conductivity of the inlet may be between 0 to 5.0 mS/cm, and the conductivity can be reduced by 25% to 90%, or greater with the RDI in certain cases, depending on the requirements of the application. The outlet from the RDI is fed back into the cooling tower basin, while the reject brine may be sent to the drain. In some embodiments incorporating such a configuration, the cooling tower no longer has to blowdown at all if the RDI is constantly removing salt/ions from the system. A brine will be generated by the RDI when operating in reject mode that is sent to drain providing sufficient blowdown.

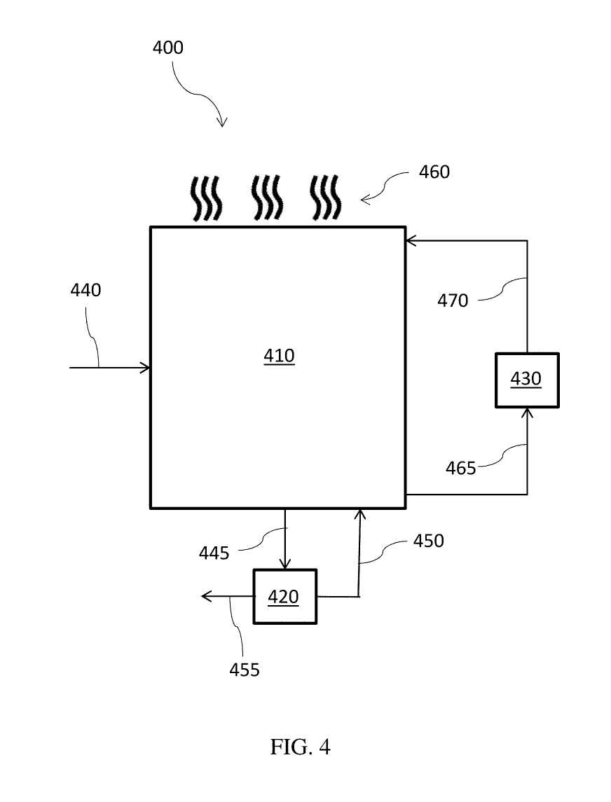

For example, FIG. 4 shows a cooling tower system 400, incorporating a side-streaming treatment operation. A cooling tower unit 410 circulates water to a heat exchanger 430, or other unit operation, via lines 465 and 470. In the cooling process some water is lost as vapor 460 and makeup water is supplied via line 440. An RDI unit 420 is incorporated into the system 400 to reduce, or in some cases eliminate, the need for a blowdown operation. During operation, the RDI unit receives water from the cooling tower unit 410 via flowline 445. Treated water is then returned to the cooling tower 410 via flowline 450. The accumulated ions in the RDI unit 420 are occasionally disposed of via purge line 455 during operation during a discharge mode.

Additional advantages may be found by combining aspects of the system shown in FIG. 4, with that shown in any of FIGS. 1-3. Because the RDI can also reduce biological activity in water by passing it through the charged capacitors thereby causing cell lysis, having a side stream polishing system (e.g. as shown in FIG. 4) in addition to the feed water RDI unit (e.g. as shown in FIGS. 1-3) can result in even lower chemical usage than by simply treating the feed water. In particular, the usage level of biocides may be less.

In some embodiments, a system may be configured to introduce different streams (e.g. from different sources) into a radial deionization unit and to produce different output streams. In operation, a first water stream (e.g., a source of make-up water) may be introduced to the radial deionization unit during a first (e.g. cleaning) cycle (i.e., while the RDI unit is operating in a cleaning cycle mode) to produce a treated water stream. The treated water stream may then be introduced to a first unit operation (e.g., a cooling tower unit). Once the capacitors of the RDI unit have become saturated with ions during the cleaning cycle, operation is switched to a second (e.g. reject) cycle to renew the RDI unit. While the same input stream may be used during both the cleaning cycle and the rejection cycle. In certain embodiments of the invention providing certain operational and flexibility advantages described below, a second water stream, different from the first water stream (e.g. from a different source and/or having a different composition), may be introduced into the radial deionization unit during a reject cycle to produce the reject stream. The second water stream may comprise, for example, a reclaimed water from the first unit operation or from a second unit operation. For example, in the context of a cooling tower system, the RDI-treated stream produced during a cleaning cycle may be introduced to the cooling tower (i.e., the first unit operation). The source of water for the RDI unit during the reject cycle could comprise reclaimed water from the same first unit operation (e.g., water from a cooling tower blowdown) or it could comprise reclaimed water from a separate, second unit operation (e.g., water from a boiler operation, air conditioner condensate, or reverse osmosis reject). By using reclaimed water during the reject cycle of the RDI unit, the system may gain additional efficiencies in water usage.

Such an arrangement may provide a novel approach to operating a desalination system, as it is not an available option with other desalination technologies, including reverse osmosis or traditional capacitive deionization, but it is feasible with a radial capacitive deionization system. Other embodiments, not shown can add a third, fourth, fifth, or more inputs and/or outputs in any number or combination—e.g. two inputs and two outputs as shown, two inputs and a single output, three inputs and three outputs, three inputs and two outputs, etc. Normally there is a single source of water that feeds into the RDI during both the clean cycle and the reject cycle. Here, there is one source of water that feeds into the RDI during the clean cycle, and another source of water that feeds during the reject cycle. This novel addition to the RDI process parameters may facilitate a wide variety of new desalination/deionization opportunities. Many new types of processes can be developed if the number of input and/or output streams increases from one to two or more. An example is using reclaimed water (i.e. blow down, air conditioning condensate, etc.) as the input for the reject cycle in order to increase the recovery rate.

In some embodiments, reclaimed water may be used to purge the RDI of brine during the reject cycle, thereby saving inlet water and increasing the recovery rate of the system. The conductivity of the reclaim water that could be used for this purge depends on the chemistry of the water, inlet salinity of the treated water, and target outlet conductivity for the clean water. In some embodiments the reject stream formed during a reject cycle may have a conductivity of between 300 μS/cm and 200,000 μS/cm.

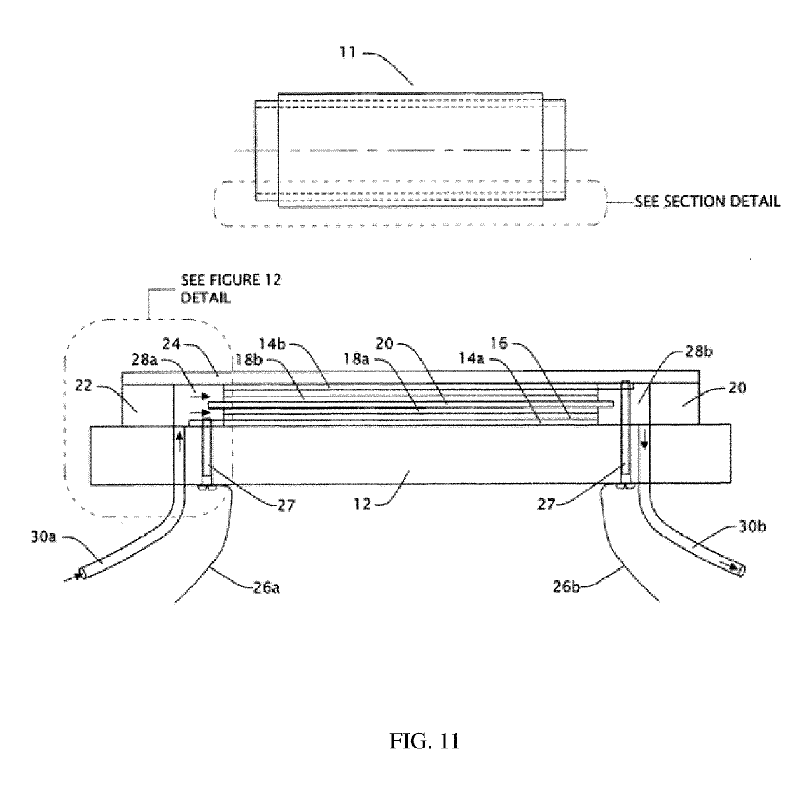

In general, the conductivity of the usable reclaim water reject cycle can be as high as 10 times or more the conductivity of the feed water during the treatment or cleaning cycle. This can eliminate the need for using fresh water to purge out brine. To reduce hold-up within the RDI unit, air may be used to fully evacuate the reject brine from the system, thereby eliminating or reducing cross contamination with the upcoming clean cycle water for treatment. RDI units are able to accept a much larger range of reclaimed water during clean and reject cycles than traditional capacitive deionization systems. The inlet salinity operating range of RDI units may be, according to some embodiments, as much as about ten, twenty, thirty, or even forty times that of traditional capacitive deionization systems. In some embodiments, the RDI unit may operate on an inlet feed having a salinity of up to 20,000 PPM, 60,000 PPM, 120,000 PPM or greater. This large performance difference is enabled, in part, by the small inlet and outlet manifolds (annuli) (for example, designated as 28a and 28b in the embodiment shown in FIG. 11 discussed below). Because this volume is small, cylinders can be fluidically connected with very short connections and operated in series. For example, in some embodiments, the inlet and outlet manifolds are approximately 385 ml each. The outlet piping from a following cylinder in series may be approximately 147.5 ml, and another 385 ml in an inlet manifold of the following cylinder results in a 1002.5 ml (1.002 lit) volume between spacer, divided by cylinder flow rate of 12.54 lit/min, results in a short period of 4.8 seconds of time between cylinders. This short residence time limits the amount of water mixed and wasted during the switch from cleaning cycle to reject cycle. These values are for purpose of illustration only, and other values may apply in different embodiments.

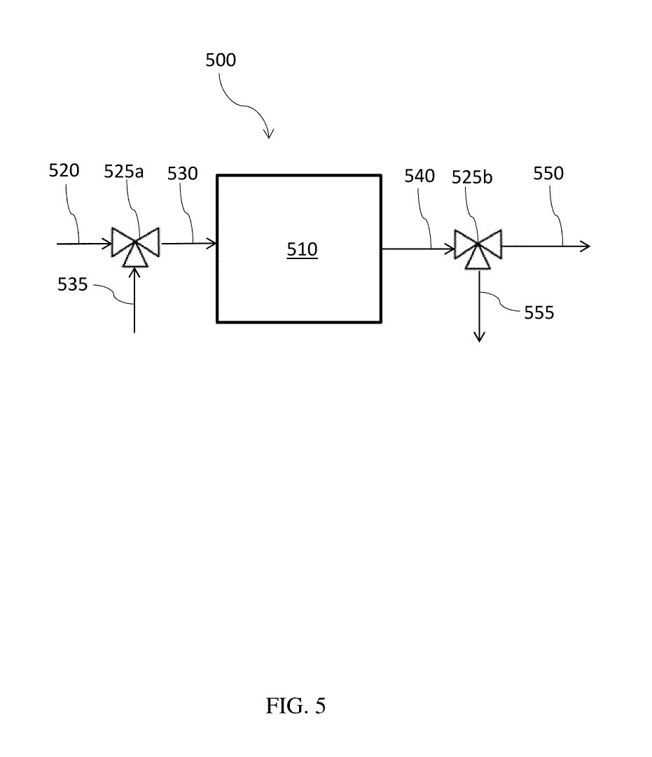

As an example of such a configuration, FIG. 5 shows a system 500 comprising a radial deionization unit 510 and an exemplary arrangement of associated valving 525a-b and flowlines (520, 530, 535, 540, 550, 555). System 500 is an example of a configuration that may be incorporated to perform the multi-stream/source process described above.

When the radial deionization unit 510 is operating in a cleaning cycle, three-way valve 525a is configured to provide a path from a first water stream into the RDI unit 510 via flowlines 520 and 530. Ionic dissolved solids are removed from the stream during the cleaning cycle by the unit 510 to produce a treated water stream. While still operating in a cleaning cycle mode, three-way valve 525b may be configured to provide a path to direct the treated water stream to a first unit operation (e.g., a cooling tower) via flowlines 540 and 550.

When the radial deionization unit 510 is operating in a reject cycle, three-way valve 525a is configured to introduce a second, different, water stream into the RDI unit 510 via flowlines 535 and 530. The second water stream may be reclaimed water. For example, it may be reclaimed water from the first unit operation (e.g., a cooling tower) to which the treated water had been initially introduced during the cleaning cycle. Alternatively, the reclaimed water may be reclaimed from a second, different, unit operation, such as a boiler or reverse osmosis unit used elsewhere in the larger system. Ionic dissolved solids that had previously been absorbed by the RDI unit 510 during a cleaning cycle are released into the flow of reclaimed water to produce a reject stream. While still operating in a reject cycle, three-way valve 525b may be configured to provide a path for the reject stream via flowlines 540 and 555 to, for example a drain or collection vessel (not shown).

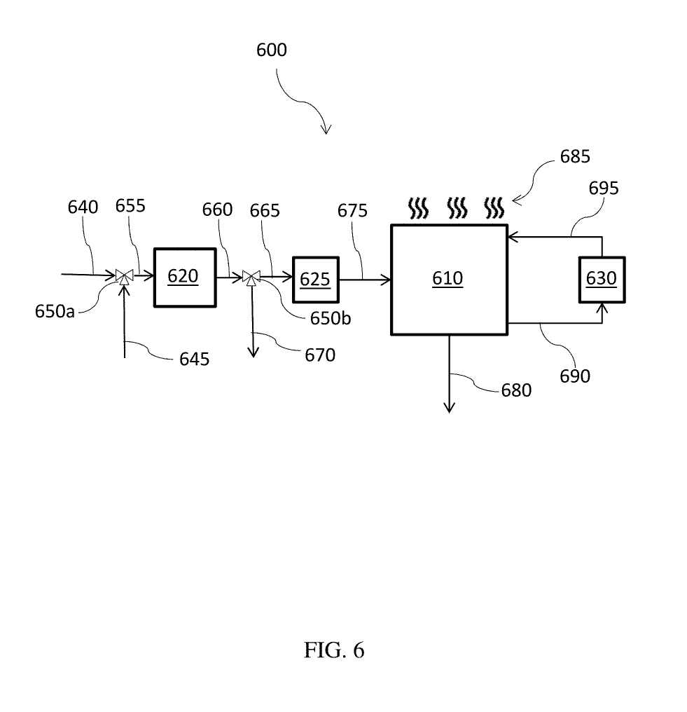

FIG. 6 shows a system 600 incorporating a similar piping scheme described above in relation to FIG. 5. In system 600, a cooling tower unit 610 is operated to provide a recirculating loop of cooling water to a heat exchanger 630 via flowlines 690 and 695. With each cycle some water is lost as vapor 685. Occasionally, blowdown via line 680 may also be necessary, when the dissolved solids concentration of the water reaches a certain point. Accordingly, make-up water must be provided to the tower 610.

In the system 600, a source of makeup water is treated by an RDI unit 620 during a cleaning cycle and further polished by a water softener 625 to provide makeup water to the cooling tower 610. By treating the make-up water in this manner and removing dissolved solids, the need for blowdowns are reduced and water is conserved. During a cleaning cycle, three-way valves 650a and 650b are configured to provide a path from the make-up source to the cooling tower 610 through the RDI unit 620 and water softener 625 via lines 640, 655, 660, 665, and 675. These lines can also be fluidically connected to the unit operation with multiple 2-way valves or other valving configurations that produce effectively the same results.

During a reject cycle, in which previously captured ions are flushed out of the RDI unit 620, the valving is reconfigured to change the source of water introduced to the RDI unit 620. For example, three-way valves 650a and 650b are arranged to provide a flow path from a second, different, source of water into the RDI unit 620 via flowlines 645 and 655, and to direct reject water produced by the unit to drain or for alternative processing via lines 660 and 670. The source of water during the reject cycle may be reclaimed water from a unit operation with the system. For example, the water stream flowing through flowline 645 may comprise blowdown water from the cooling tower unit 610. Alternatively, the source of water during the reject cycle may comprise water reclaimed from a different unit operation (not shown in FIG. 6) of the system 600, such as a boiler, or clean and brine/reject from a reverse osmosis operation. The ability of the RDI unit 620 to operate with water from different sources during its different cycles, provides the advantageous capability of utilizing reclaimed water that may be otherwise wasted during its reject cycle. By using reclaimed water during the reject cycle rather than continuing to use the same source as the make-up water, the system 600 is able to conserve additional water, resulting in more efficient operation.

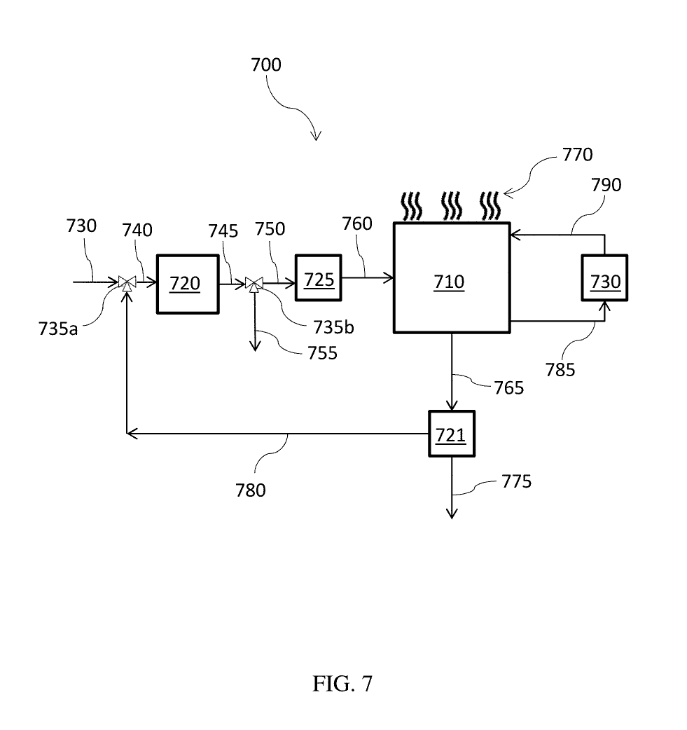

Another embodiment of a system incorporating an RDI unit and associated piping, like that described above with regard to FIG. 5, is shown in FIG. 7. S 700 is characterized by a design that provides additional water savings by treating blowdown water and reclaiming it for use within system 700. System 700 comprises a cooling tower 710 operated to provide a recirculating loop of cooling water to a heat exchanger 730 via flowlines 785 and 790. With each cycle some water is lost as vapor 770. Occasionally, blowdown via line 765 may also be necessary, when the dissolved solids concentration of the water within the cooling tower 710 reaches a certain point. Accordingly, make-up water must be provided to the tower 710. In system 700, when a first RDI unit 720 is operating in a cleaning cycle mode, three-way valves 735a and 735b are configured to provide a flow path from a source of make-up water to the RDI unit 720 to an optional water softener 725 to the cooling tower 710 via flowlines 730, 740, 745, 750, and 760.

By reducing the dissolved solids content of the make-up water introduced to the cooling tower unit 710, the number of system blowdowns via flowline 765 are reduced. Nevertheless, the blowdown water of system 700 is not simply sent to waste. Instead, in this embodiment, a second RDI unit 721 is provided to receive the blowdown water via line 765. The second RDI unit 721, when operated in a cleaning cycle mode, treats the concentrated blowdown water to provide an output with a dissolved solids content sufficiently reduced so as to provide an effective reclaimed water source delivered via flowline 780 for use while the first RDI unit 720 is operating in a reject cycle mode. (In alternative embodiments, the reclaimed water can be more fully treated to make it suitable as make-up water.) When the blowdown RDI unit 721 operates in a reject mode, the concentrated reject stream is delivered to drain or further processing via flowline 775.

When the first RDI unit 720 is operating in a reject cycle mode, three-way valves 735a and 735b are configured for the RDI unit 720 to receive a reclaimed water source from the blowdown RDI unit 721 via flowlines 780 and 740, and then deliver the produced reject stream to drain or further processing via flowlines 745 and 755.

Some system components may be included that are not shown in FIGS. 1-7. For example, any of these systems may include a reserve tank of desalinated feed water for high demand periods. Because the cooling tower demand may vary significantly during a period of operation, cleaned water could be stored for high demand periods. By doing this, the system size can be minimized yet provide maximum benefits.

Embodiments described above may result in a number of additional advantages over alternatives. For example, in some embodiments of the described systems and methods, the RDI units may not require silica, hardness, alkalinity, or chlorine to be removed from the system, the way other desalination systems may. This tolerance of silica- and chlorine-based biocides and disinfectants may eliminate or reduce the need to remove these species prior to desalination, and in the case of chlorine based chemicals, the re-introduction in order to help control biogrowth in the cooling tower. This capability further separates the RDI in terms of associated costs. This capability applies to applications other than cooling towers as well.

Some embodiments of the described systems and methods have a wider range of tolerable temperatures, than do systems incorporating alternative desalination techniques. Many cooling tower applications require desalination systems that can tolerate elevated temperatures. Certain RDI systems of the invention can not only tolerate temperatures above the maximum 40° C. limit for RO, but can perform equal or better at elevated temperatures than at ambient temperatures. Certain RDI systems of the invention can tolerate feed temperatures up to 60° C., and some as high as 90° C.

Some embodiments of the described systems and methods, provide a flexibility associated with an adjustable output salinity and variable inlet salinity. Unlike reverse osmosis which can only product a single output salinity, certain embodiments of the RDI systems can adjust the output salinity by simply changing a setpoint on a controller (e.g. a conductivity sensor and controller). This can be helpful to reduce the operating cost of this system with a cooling tower as in many cases it is not necessary, or even desired, to removal all salinity.

Some embodiments of the described systems and methods provide advantages regarding flow rate optimization. In some embodiments, RDI systems have the ability to desalinate water at comparatively high flowrates. The lower inlet salinity of many cooling tower applications coupled with the partial desalination needs enables the use of relatively high flow rates through the RDI units of certain embodiments. The higher flow rates can increase the flux rate of the system, thereby allowing for smaller systems to be utilized. For example, in some embodiments RDI systems can handle flow rates between 0.01 liters per minute per square meter of active material and 1,000 liters per minute per square meter of active material. Alternatively, In some embodiments, RDI systems can handle flow rates between 0.0001 liters per minute per square meter of surface area of installed membrane/electrode (active material) capable of absorbing ions, and more than 0.1 liters per minute per gram of active material. In some embodiments, RDI systems can handle a linear water velocity through the device between 0.001 meters per second and 1 meter per second. In some RDI systems, flowrate of water can be between about 50 ml/min/m² of active capacitor material and about 3,000 ml/min/m² of active capacitor material, and in some embodiments between about 1, 500 and 3,000 ml/min/m². In some embodiments, the water flows through a cylinder with multiple cells of capacitors that have approximately 0.5 m² of active materials per cell.

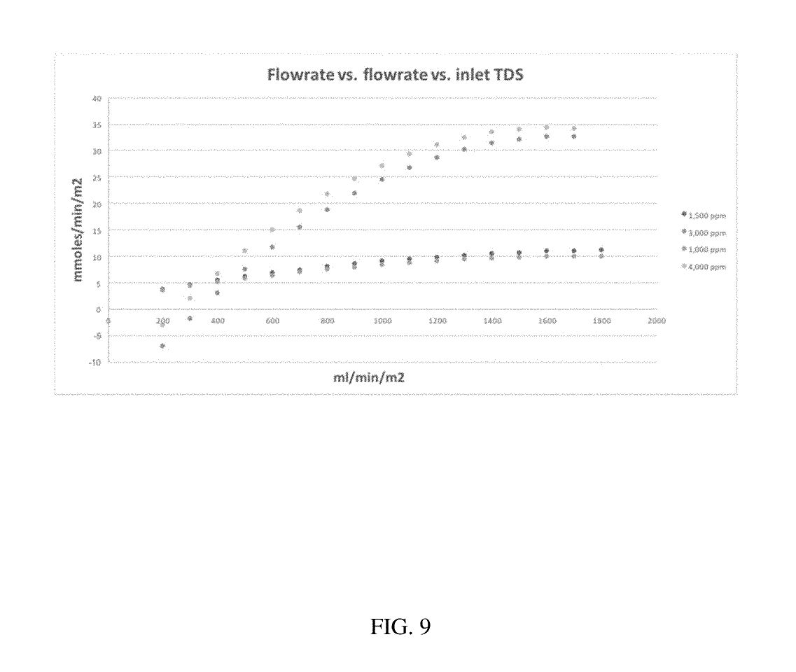

RDI systems can provide the ability to treat water at a higher flow rate than typical traditional capacitive deionization systems. These higher flow rates result in an increase in the flux rate of the system, thereby allowing for smaller systems to be utilized. By flowing faster, the flux rate (mmoles/min per m² of active material rises as shown in FIG. 9. The higher the flux rate, the less active area of material is typically needed, consequently allowing for lower capital and maintenance costs. Without being bound to a particular theory, the mechanism of this flux-performance effect is likely due to improved mass transport via the refreshing of the surface of the membrane on which salt to be removed resides by the increased flow velocity which also likely reduces the electrical resistance of the capacitor which in turns increases the rate of removal of salt.

In some embodiments RDI systems are retrofitted into the cooling tower system design. In other embodiments, RDI systems are incorporated into the original design of a cooling tower. All of the system construction/modifications described herein can in certain embodiments be done after a cooling tower is installed, but there may be certain cost and infrastructure advantages to incorporating an RDI unit directly into the initial design of the cooling tower. Integrating the cooling tower and RDI designs may not only reduce the total capital cost, but may may allow for improved performance due to integration of controls, shortened pipe lengths, optimized sizing of components, optimized process set points for both systems, etc.

Some or all of certain embodiments of the above-described systems and processes described herein may be configured and operated to improve the water efficiency of an evaporative cooling tower. The various components, such as the RDI and water softener, can be reconfigured within the facility depending on the application and the system requirements.

Various aspects of the system, including control parameters, may be optimized according to a number of considerations, including to minimize costs of capital equipment, maintenance costs, costs of operation, etc. Such variables and performance matrics for optimization may include the following: inlet salinity of feed water to RDI; projected outlet salinity from RDI; conductivity set point to initiate blowdown; blowdown rate; feed rate of makeup water; current tower cycles of concentration (the ratio of the concentration of dissolved solids in the blowdown water compared to the make-up water); evaporation rate; chemical usage ($/kgal of blowdown); price of power; and price of feed water/sewerage charges, etc. The optimization may be guided in certain embodiments through use of a savings model.

According to certain embodiments, a control system may be incorporated into the system to improve the operation of the RDI units and other system components. The control system may comprise a controller, at least one input device (e.g., a sensor), and at least one output device (e.g., a pump). The controller may be configured to receive an input signal from the input device and to deliver an output signal, in response to the input signal, to the output device. For example, in certain embodiments, the RDI unit and/or cooling tower may be coupled to a controller configured to receive an input signal from a sensor monitoring a salinity in the tower, and to deliver an output signal, in response to the input signal, to a pump and/or valve controlling blowdown.

Unlike reverse osmosis which can only be fed by its own high pressure pump and produce a single output salinity, in some embodiments the output salinity from the RDI can be adjusted by changing a set point on the controller. This can be helpful to reduce the operating cost of this system with a cooling tower as in many cases it is not necessary, or even desired, to removal all salinity. A new output salinity may result in changes to the flowrate of the system and/or the set point of the control valve directing treated water to enter the clean tank/pipe. By monitoring the conductivity of the outlet water, the controller can calculate the average salinity of the treated water, thereby controlling the salinity.

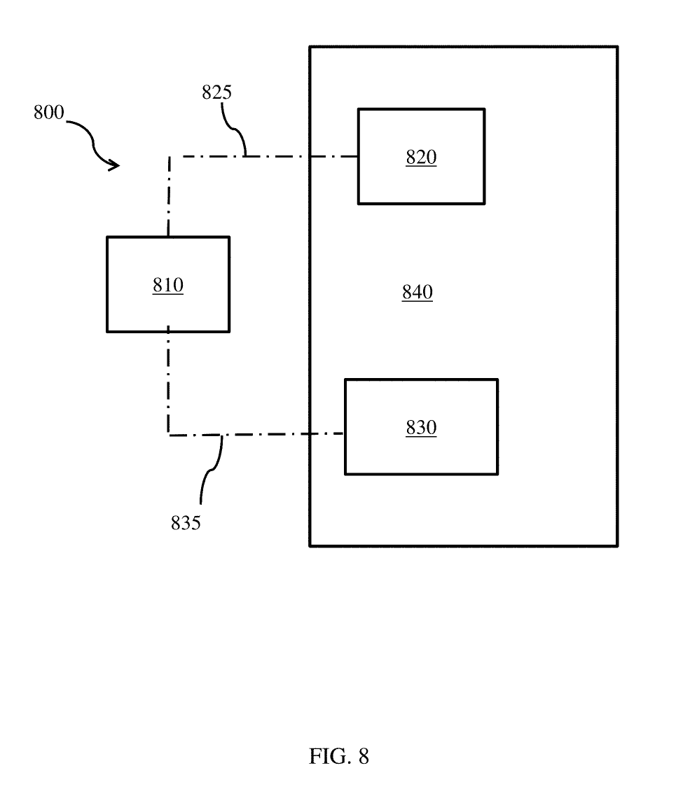

For example, FIG. 8 shows a representative control system 800. The control system 800 comprises a controller 810, an input device 820, and an output device 830 coupled together. The controller 810 may receive an input signal 825 from the input device 820 corresponding to a measurement taken by the input device 820. In response to the input signal 825, the controller 810 may deliver an output signal 835 to the output device 830 directing the operation of the output device. In FIG. 8, a cooling tower system 840 is coupled to the controller 810, so that the controller 810 aids in operations related to the system 840.

The input device 820 may comprise a sensor or monitor. The input device may comprise a sensor configured to monitor a parameter of the system 840. The input device 820 may be placed within or in proximity to the system 840. For example, the input device 820 may comprise an conductivity measurement instrument calibrated to indicate the salinity level within the cooling tower. The input device may regularly or continuously transmit the level value to the controller via the input signal 825.

The output device 830 may comprise a device that affects a system parameter. For example, the output device 830 may comprise a pump in fluidic communication with a blowdown outlet from the cooling tower. The output device may be controlled by the controller 810 via output signal 835.

According to some embodiments, the controller comprises a PID controller that operates according to a proportional-integral-derivative control loop. However, other control loop feedback mechanisms may be used, as would be understood by a person of ordinary skill in the art.

In some embodiments an input sensor may comprise a cooling tower water level sensor that monitors the water level in the cooling tower. An output signal may be directed to control the operation of the RDI in response to this input signal. These output signals may determine when to turn on and off the RDI unit. Make-up water flow rate and evaporation rates should be matched and monitored in order to make sure the tower does not run out of water. In response to the level sensor signals, the controller may also direct the RDI to produce water for other applications while it is waiting for the tower to request water. By monitoring the tower water level, RDI system, and blowdown, the operation of the tower may be optimized.

In some embodiments, an input sensor may comprise a sensor monitoring the inlet conductivity of feed water to the RDI unit. By monitoring inlet conductivity, the RDI can optimize performance by adjusting outlet conductivity, energy usage, flowrate, uptime, etc.

In some embodiments, an input sensor may comprise sensors monitoring the inlet and outlet conductivity of water from the RDI unit and water level in the cooling tower. By monitoring these, the RDI unit can optimize performance by adjusting outlet conductivity, energy usage, flowrate, uptime, etc.

By monitoring key aspects of tower performance, the RDI may be shut off when needed, saving water, energy, and maintenance. Alternatively, the RDI unit may produce water for other applications during downtime. By monitoring the cooling tower performance, the RDI unit, in certain embodiments, can produce water for other plant needs during times when cooling tower demand is low such as at night, cooler weather, cloudy days, etc.

As described above, certain embodiments of the inventive systems include one or more computer implemented control systems (programmable logic controllers, or PLC's) for operating various components of the water treatment system, (e.g., controller 810 of the computer implemented control system 800 shown in FIG. 8). In general, any calculation methods, steps, simulations, algorithms, systems, and system elements described herein may be implemented and/or controlled using one or more computer implemented control system(s), such as the various embodiments of computer implemented systems described below. The methods, steps, control systems, and control system elements described herein are not limited in their implementation to any specific computer system, as many different machines may be used.

The computer implemented control system can be part of or coupled in operative association with an RDI unit and/or cooling tower of a system and/or other automated system components, and, in some embodiments, is configured and/or programmed to control and adjust operational parameters, as well as analyze and calculate values. In some embodiments, the computer implemented control system(s) can send and receive reference signals to set and/or control operating parameters of system apparatus. In other embodiments, the computer implemented system(s) can be separate from and/or remotely located with respect to the other system components.

Various of the unit operations described herein can be “directly fluidically connected” to other unit operations and/or components. Generally, a direct fluid connection exists between a first unit operation and a second unit operation (and the two unit operations are said to be “directly fluidically connected” to each other) when they are fluidically connected to each other and the composition of the fluid does not substantially change (i.e., no fluid component changes in relative abundance by more than 5% and no phase change occurs) as it is transported from the first unit operation to the second unit operation. As an illustrative example, a stream that connects first and second unit operations, and in which the pressure and temperature of the fluid is adjusted but the composition of the fluid is not altered, would be said to directly fluidically connect the first and second unit operations. If, on the other hand, a separation step is performed and/or a chemical reaction is performed that substantially alters the composition of the stream contents during passage from the first component to the second component, the stream would not be said to directly fluidically connect the first and second unit operations.

It should also be understood that, where separate units are shown in the figures and/or described as performing a sequence of certain functions, the units may also be present as a single unit (e.g., within a common housing), and the single unit may perform a combination of functions.

It should also be understood that a number of different unit operations, not shown in any of the figures, may be performed at various stages of the system either upstream of one or more inlets to the cooling tower or downstream of one or more outlets from the cooling tower.

FIGS. 10-12 provide further description of selective embodiments of exemplary radial deionization devices that may be useful for practicing certain disclosed embodiments. In addition to the concentric layer design described with regard to these figures, spiral wound embodiments are also potentially useful as an RDI unit for the purposes of this disclosure.

Turning to the embodiment shown in FIGS. 10-12, a basic concentric layer electric double layer capacitor (EDLC) cylinder 11, comprises two or more tubular electrodes or capacitors 16, one inserted inside of the other forming a concentric pair of capacitors 16. One pair of capacitors 16 forms an electric double layer capacitor 16 pair.

In the design shown in FIG. 11, an inner most capacitor 16 is wrapped around a current collector 14a, which could be graphite, hollow metallic tube or a non-metallic hollow tube 12 with a metallic coating, sleeve, or thin current collector 14a. Around this inner capacitor 16 could be an ionic membrane 18a or an ionic coating integrated onto a surface of capacitor 16. Next, a dielectric spacer, insulator, or spacer 20 would surround a capacitor 16 or membrane 18 which would allow for a liquid layer to flow through cylinder 11. Around this layer would be another ion selective membrane 18b, another capacitor 16, and then another current collector 14b.

Around perimeter of each end of hollow support tube 12 is an optional o-ring 22 to seal ends of cylinder 11. A sealing layer 24 wraps around cylinder 11, extending out to o-rings 22 which will completely seal cylinder 11 and provide means to compress layers within cylinder 11 securely against inner support tube 12.

Process liquid connections 30a and 30b to cylinder 11 mount on the inside of inner support tube 12 and allow for liquid access to inlet 28a and outlet chambers 28b. Electrical connections 26a and 26b to cylinder 11 are also made through inner surface of inner mounting tube 12.

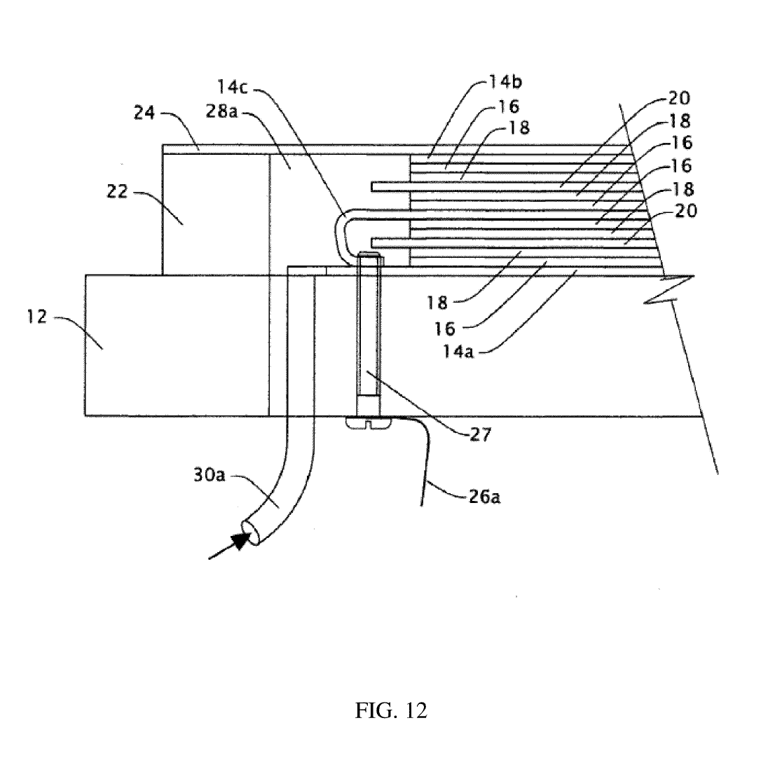

FIG. 12 shows a detail view of a concentric layer EDLC with a plurality of EDLC pairs visible. The structure of a multiple pair concentric layer EDLC is the same as illustrated in FIG. 11 except that an internal current collector 14c is placed onto second capacitor 16. On top of current collector 14c is placed another capacitor 16, another membrane 18, another dielectric spacer 20, another membrane 18, and then another capacitor 16. This sequence can be repeated until the desired number of pairs of capacitors 16b is installed onto inner mounting tube 12.

When cylinder 11 is operating as capacitive deionization device, liquid to be processed such as water enters cylinder 11 through inlet tube 30a into inlet chamber 28a. The liquid passes axially through spacer(s) 20, into outlet chamber 28b and then out of cylinder 11 through tube 30b. The size of chambers 28a and b can be further reduced by filling with a space filling material such as foam.

Electrical leads 26a and 26b are connected to a direct current power supply (DC). The simplest cylinder design with one EDLC pair has one capacitor 16 connected to one leg 33 of the power supply and capacitor 16 connected to leg 33b. The power supply is turned on and each capacitor 16 is charged to the voltage set on the power supply. In some embodiments, the power supply would be set to 2.2 volts when processing aqueous liquids.

If capacitor 16 nearest inner support tube 12 is charged positive it will attract negatively charged ions (anions). If membrane 18a proximal to this capacitor 16 is anionic, it will allow anions from the liquid in spacer 20 to pass through and adsorb onto capacitor 16. This adsorption will continue until the amount of ionic charge adsorbed onto capacitor 16 equals the charge capacity of capacitor 16. Conversely, capacitor 16 nearest outer casing 24 will be charged negative and attract positively charged ions (cations). If membrane 18b proximal to this capacitor 16 is cationic, it will allow cations to pass through until capacitor 16 is full.

Once capacitors 16 have adsorbed the prescribed amount of ions (partial or full adsorption), the polarity of the power supply is switched. Capacitor 16 that was charged positive is now switched to negative and other capacitor 16 is switched to positive. The ions that were adsorbed onto the surface are now repelled towards oppositely charged capacitor 16. Since opposite ion specific membranes are placed in front of each capacitor 16, the repelled ions cannot pass through opposite membrane 18 and are prevented from adsorbing onto other capacitor 16. These rejected ions are held within spacer 20 and can be expelled from cylinder 11.

After all the ions have been dislodged from capacitors 16 and cylinder 11, the adsorption and rejection process can be repeated. If a 3 way valve (or multiple 2 way valves) is placed on outlet tube 30b, the deionized liquid can be diverted away from the liquid containing the rejected ions. Cylinder 11 power supply will switch the polarity back and forth, removing ions from solution and depositing the ions back into solution, creating a deionized portion and a portion containing the removed ions.

Typical component sizes and materials of construction according to certain embodiments are as follows. The inner support tube 12 can be made of fiber reinforced epoxy resin, fiber reinforced polyester resin, schedule 40 or 80 ABS pipe, PVC, PPE, PP, or the polymers with semi-rigid structure. The current collector 14a, 14b, or 14c is typically made of less than 0.005″ commercial grade titanium. The carbon capacitor 16 is typically made of activated carbon, >0.005″ thick, with surface area greater than 1,000 m³/gm. The spacer 20 can be made of many woven and nonwoven insulating materials such as hemp, nylon cloth, polypropylene, or other non-conductive materials that wet-out in water with open volume less than 75% and thickness greater than 0.005″. The optional o-rings 22 sealing each end can be made from rubber, silicone, PTFE, or other flexible sealing materials.

With a 12-15 inch long, 8-16 inch diameter, single pair concentric EDLC, inlet 28a and outlet 28b chambers will be no bigger than 20 cm³ or 20 ml, according to some embodiments. A cylinder of this configuration would allow for flow of approximately 2,500 ml/min. This translates into a residence time or dead volume of less than 1 second. As additional pairs are added to cylinder 11 the dead volume will rise less than proportional, further reducing the residence time in chambers 28a and 28b. By reducing the residence time in outlet chamber 28a to less than 1 second, there is a clear delineation between cleaned and purged liquid streams when the polarity is switched.

Using the same diameter cylinder mentioned above, the residence time of the open space contained in spacer 20 is less than 2 seconds, according to certain embodiments. The velocity of the liquid within spacer 20 has a Reynold's number greater than 2,000 thereby creating a great deal of turbulence which will facilitate the removal of ions after being ejected from capacitors 16 during the discharge cycle, according to certain embodiments.

The combination of these two features significant reduces the effect of the problem of the clean stream being mixed with stream containing the rejected ions.

The pressure drop across a standard 8 inch diameter by 12 inch cylinder with one EDLC pair of capacitors 16 and 1 liter per minute is less than 10 psi with a residence time of less than 5 seconds, according to certain embodiments. This allows for cylinders to be placed in series to provide high levels of purification. By placing cylinders in series, the ratio of circumference to length can be adjusted without changing cylinder 16 itself. This flexibility allows for cylinders to be used in various combinations to process different streams with varying purification goals.

Current collectors 14a and 14b, or integrated capacitor 16/current collectors 14, are very close to inside and outside of the cylinder 11. This allows for simple and effective electrical connection to outside power source. A non-porous current collector is employed, thereby reducing the electrical resistance such as described above. When employing multiple EDLC pairs within cylinder 11, non-porous collectors 14c are used to facilitate assembly and reduce electrical resistance.

Higher flow rate of RDI (ml/min/m²) across active material increases the removal rate of salt (gms/min/m²), thereby requiring less super capacitors and hence lower system cost. In some embodiments, the RDI unit operates as a constant voltage system, thereby delivering higher average current density to the capacitors. Higher current density equates to a higher removal rate of salt, thereby further reducing the size and cost of system. As system size is reduced, so is maintenance cost per unit of water produced. The capacitor design allows for a shorter path for the water to travel, improving the clean water recovery.

In some embodiments the capacitors may have a spiral shape, rather than a concentric circle shape, disposed about a central axis. The spiral form of the RDI design embodies all of the performance attributes of the concentric layer design in terms of reduced dead volume, flow rate per m², high inlet salinity capability, cylinder-cylinder series connection, etc. The internal electrical connections, inlet/outet piping, length, diameter, weight are also equivalent to the concentric design. The difference is the manner in which the layers are prepared and installed.

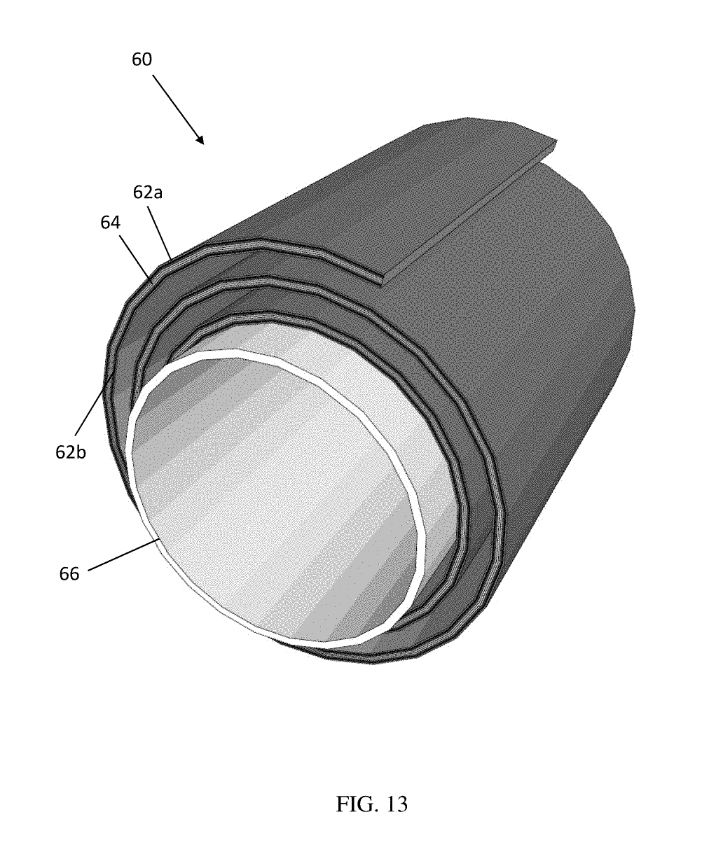

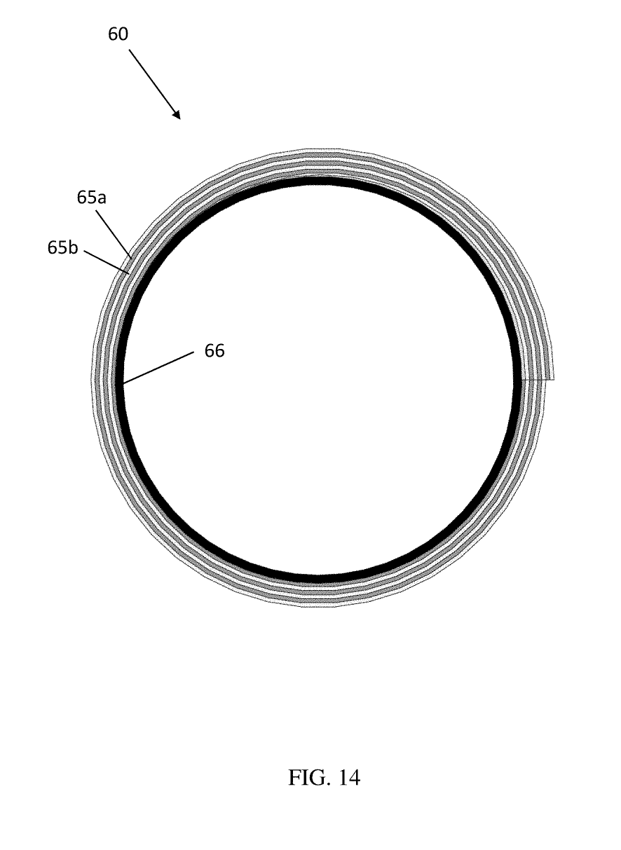

As shown in FIG. 13, a group of pre-arranged layers of material comprising capacitors 62a and 62b and a spacer region for fluid flow 64 are wrapped around the RDI core 66. This group is organized such that the surfaces that come in contact with each other are the same polarity. In this embodiment, two sets of super capacitor pairs 62a and 62b are pre-arranged and then wrapped around the core 66. When the desired surface area of active materials are installed, the wrap is terminated and outer casing installed. For the sake of clarity, FIG. 13 does not show all components of the cylinder 60 and shows the material in a looser form than would be the case in the final configuration. FIG. 14 shows the completed layer cross-section. The cylinder 60 of FIG. 14 shows two cells 65a and 65b wrapped around the core 60. Each of the cells 65a and 65b comprises a spacer region with capacitor material on either side. It looks very similar to the finished concentric and allows for the same flow distribution and flow rate per square meter of material.

The RDI units may remove any dissolved solid in solution. This includes but is not limited to the following cations: Li, Na, Ca, Mg, K, U, Hg, Se, Ba, Sr, Fe, Mn, Cr, Ni, Cu, Zn, Sn, Sb, Pb, Ag, Au, Cd, Hg, B, Bi, etc.; and the following anions Anions: Chlorides, sulfates, sulfides, sulfites, nitrates, phophates, carbonates, borates, silica, selenates, selanites, bromides, iodides, alkalines, etc. The species removed by a water softener typically used as pretreatment may remove permanent hardness (calcium, magnesium, sulfates, carbonates) as they are the low solubility species that cause issues when concentrated up above their maximum solubility levels. In some embodiments the RDI unit is operated allow at least one ionic species to pass through without substantial removal from the water to produce the treated water. For example, it may be desired to not remove silica or chlorine in some applications.

The following examples are intended to illustrate certain embodiments of the present invention, but do not exemplify the full scope of the invention.

### Example 1

An RDI unit was coupled to a cooling tower system in an arrangement similar to that shown in FIG. 1. The RDI unit was a 24 cylinder unit arranged in parallel, operated at 48V direct current, to treat a pressurized city water feed. Each cylinder had an active material surface area of about 13 square meters. The RDI unit produced clean water at a rate of approximately 50 GPM. The cooling tower system comprised four cooling towers with analog level sensors feeding continuous operating data to the RDI. The cooling tower system had an average water usage of 16,000,000 gal per year, or approximately 30.5 gpm. The system comprised four towers each having dimensions of 20″×8′×8′ for a total of 256.4 gal each, and a total of 1,026 gal taken together. Sensors monitor water level with high/low water level sensing points of 20 inches and 10 inches. The inlet flowrate for makeup water is 30 gpm. The blowdown conductivity setpoint is a TDS of 1,750 ppm, or approximately 3,200 μS/cm. The blowdown flowrate is approximately 5 gpm. The cooling tower cycles of concentration (the ratio of the concentration of dissolved solids in the blowdown water compared to the make-up water) was 2.9 without installation of RDI. With RDI installed, the cycle rate is able to reach 6.0. The inlet feed into the RDI has a conductivity of 800 μS/cm and a TDS 500 ppm.

### Example 2

A cooling tower was coupled to an RDI unit was produced in a configuration like that shown in FIG. 1. The RDI unit had three cylinders arranged in parallel, operating at 2V per cylinder. Each cylinder had an active material surface area of about 13 square meters. With a flow rate through the RDI unit of 1 liter/min. The RDI received a water stream having a TDS of 575 ppm, and treated it to produce a treated stream having a TDS of 75 ppm. The system had a water recovery rate of 92%. The cooling tower cycles of concentration (the ratio of the concentration of dissolved solids in the blowdown water compared to the make-up water) went from 4.7 to 7.0 after the RDI system was installed producing a projected water savings of 2,000,000 gal/yr and projected chemical savings of $24,000/yr, A trial where the input silica was 15 ppm, and outlet was the same, demonstrating that silica is able to pass straight through the system, as desired. The typical chlorine level of city water was also the same as inlet, again demonstrating that the system may allow this additive to pass through as desired.

### Example 3

A cooling tower was coupled to an RDI unit was produced in a configuration like that shown in FIG. 1. The RDI unit had four cylinders arranged in parallel, operating at 1.8V per cylinder, with a flow rate through the RDI unit of 8 liter/min. Each cylinder had an active material surface area of about 13 square meters. The RDI received a water stream having a TDS of 348 ppm (520 μS/cm), and treated it to produce a treated stream having a TDS of 235 ppm (350 μS/cm). The system had a water recovery rate of 89%. The cooling tower cycles of concentration went from 2.9 to 4.3 after the RDI system was installed.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An evaporative cooling system comprising:
a cooling tower unit; and
a radial deionization unit fluidically coupled with the cooling tower unit.

2. The system according to claim 1, wherein the radial deionization unit comprises capacitors having a concentric circular shape or spiral shape disposed about a central axis.

3. The system according to claim 1, wherein the radial deionization unit is fluidically positioned between the cooling tower unit and a source of makeup water for the cooling tower unit.

4. The system according to claim 3, further comprising a water softener fluidically positioned between the cooling tower unit and the source of makeup water for the cooling tower unit.

5. The system according to claim 4, wherein the source of makeup water for the cooling tower unit is reclaimed water from the cooling tower unit and wherein the water softener is fluidically positioned between the cooling tower unit and the radial deionization unit.

6. The system according to claim 1, wherein the radial deionization unit is fluidically positioned to receive water from the cooling tower unit, and to treat and return the received water to the cooling unit.

7. A method for operating an evaporative cooling system, comprising:
treating water from a source of water in a radial deionization unit to produce a treated water; and
delivering the treated water to a cooling tower unit of the evaporative cooling system.

8. The method of claim 7, wherein treating the source of water in a radial deionization unit comprises feeding the water into the radial deionization unit and at least partially removing at least one ionic species from the water to produce the treated water.

9-11. (canceled)

12. The method of claim 8, wherein treating the source of water in a radial deionization unit comprises feeding the water into the radial deionization unit having a conductivity of between about 300 μS/cm and 200,000 μS/cm, and at least partially removing at least one ionic species from the water to produce the treated water, wherein the treated water has a conductivity of between 30 μS/cm and 200,000 μS/cm.

13. The method of claim 7, wherein treating the water from the source of water in a radial deionization unit comprises producing treated water with the radial deionization unit at a rate of at least about 50 ml/min per m² of an active capacitor material.

14. The method of claim 13, wherein treating the water from the source of water in a radial deionization unit comprises producing treated water with the radial deionization unit at a rate of between about 1500 ml/min per m² of an active capacitor material and about 3,000 ml/min per m² of the active capacitor material.

15. The method of claim 7, further comprising polishing the treated water in a water softener prior to delivering the treated water to the cooling tower unit.

16. The method of claim 7, wherein the system has a water recovery rate of at least 90%.

17. The method of claim 7, wherein treating the source of water in a radial deionization unit comprises allowing at least one ionic species to pass through without substantial removal from the water to produce the treated water.

18. A water treatment method using a radial deionization unit to produce a treated water stream, the method comprising:
introducing a first water stream to a first radial deionization unit during a first cycle of operation of the first radial deionization unit to produce the treated water stream;
introducing the treated water stream to a first unit operation; and
introducing a second water stream to the first radial deionization unit during a second cycle of operation of the radial deionization unit to produce a reject water stream;
wherein the second water stream comprises reclaimed water from the first unit operation or from a second unit operation.

19. The method of claim 18, wherein the first cycle of operation of the first radial deionization unit is a water cleaning cycle in which at least one ionic species is at least partially removed from the first water stream to produce the treated water stream; and wherein the second cycle of operation of the first radial deionization unit is a reject cycle, in which ionic species retained by the first radial deionization unit during the water cleaning cycle are rejected into the second water stream to produce the reject water stream.

20. The method of claim 19, wherein the first unit operation comprises a cooling tower unit.

21. The method of claim 20, wherein the second water stream comprises reclaimed water from the cooling tower unit.

22. (canceled)

23. The method of claim 21, wherein the reclaimed water from the cooling tower comprises blowdown water, and further comprising treating the blowdown water with a second radial deionization unit prior to introduction into the first radial deionization unit during the reject cycle.

24. The method of claim 20, wherein the second water stream comprises reclaimed water from the second unit operation.

25-27. (canceled)
